(19) United States
(12) Patent Application Publication
(10) Pub. No.: US 2026/0122323 A1
(43) Pub. Date: Apr. 30, 2026

(54) METHOD AND APPARATUS FOR IDENTIFYING VIDEO SOURCE SOFTWARE BASED ON METADATA EXTRACTION FROM MULTIMEDIA FILE

(71) Applicant: Korea University Research and Business Foundation, Seoul (KR)

(72) Inventors: Jungheum Park, Seoul (KR); Junho Kim, Seongnam-si (KR); Hyomin Yang, Seoul (KR)

(21) Appl. No.: 19/369,048

(22) Filed: Oct. 24, 2025

(30) Foreign Application Priority Data
Oct. 28, 2024 (KR) 10-2024-0148742

(51) Int. Cl. H04N 21/84; G06F 18/2135; H04N 19/70; H04N 21/235

(52) U.S. Cl. CPC H04N 21/84; G06F 18/2135; H04N 19/70; H04N 21/2353

(57) ABSTRACT

An apparatus for identifying video source software according to an embodiment may perform an operation of acquiring a dataset including a video file transmitted by predetermined software; an operation of extracting a value of metadata including a container file format of each video file, internal data of a container file, and an encoding parameter; and an operation of generating a classification model based on a deep learning algorithm that has learned a parameter reflecting a correlation between the value of the metadata of each video and software from which each video file is transmitted.

### CROSS-REFERENCE TO RELATED APPLICATION

This application claims priority under 35 U.S.C § 119 to Korean Patent Application No. 10-2024-0148742 filed in the Korean Intellectual Property Office on Oct. 28, 2024, the entire contents of which are hereby incorporated by reference.

### BACKGROUND OF THE INVENTION

### Field of the Invention

The present invention relates to a technique of extracting metadata in a multimedia file and identifying software from which a video file is transmitted based on the metadata, and may be utilized in various fields such as digital forensic, cybercrime investigation, copyright protection, and prevention of distributing illegally filmed materials.

Meanwhile, this application has been supported by the national research and development projects as described below.
[Project Unique Number] 1711170650
[Project Number] 2022-0-00281-001
[Ministry Name] Ministry of Science and ICT
[Title of Project Management (Specialized) Organization] Institute of Information & communications Technology Planning & Evaluation
[Title of Research Business] Development of Information Protection Core Technology (Information and Communication Promotion Fund)
[Title of Research Project] Development of Digital Evidence Analysis Techniques Using Artificial Intelligence Technique
[Title of Project Implementing Organization] Sungkyunkwan University Research and Business Foundation
[Research Period] Apr. 1, 2022-Dec. 31, 2025

### Background of the Related Art

Video files can be generated in various digital devices, and transmitted and shared through a variety of software. Therefore, techniques for identifying software from which a video file is transmitted plays an important role in investigation of cybercrimes, resolution of copyright infringements, and prevention of distributing illegally filmed materials as it can find out the source of video files.

Recently, as smartphones and small cameras are widely used, cases of illegally filming and distributing videos are increasing rapidly, and as the environment of easily sharing high-capacity high-definition videos has been created with the development of Internet techniques, criminal acts according to illegal distribution of videos occur more frequently.

As the media and methods for generating videos and software that transmits the videos become more diverse day by day, techniques for accurately identifying diverse software from which video files are transmitted also need to be developed.

Previously, a method of confirming specific metadata of a video file is mainly used to identify software from which a video file is transmitted. The metadata provides various technical information contained in the video file, and information such as the device that has created the video file, the codec used for the video file, a resolution thereof, and the like can be identified through the metadata. In addition, as some software may change the metadata in the course of transmitting or processing the video file, source software from which the video file is transmitted can be estimated to some extent based on the change.

However, there are some limitations in the existing techniques of analyzing metadata of video. First, one of the limitations is variability of metadata. Various software can re-encode metadata, or delete or alter some information while transmitting video files, and this may invite confusion in identifying the source of a video file. Furthermore, metadata of a video file may use different formats according to software, and it is difficult to clearly identify the source of specific software.

However, existing metadata analysis methods are methods of estimating the source by confirming presence or absence of specific metadata, and may not reflect a unique processing process of software in many cases.

Therefore, to solve these problems, required is a new approach that can analyze metadata of a video file in more detail and reflect the difference in the re-encoding process or metadata processing method that varies in each software.

### SUMMARY OF THE INVENTION

Therefore, the present invention has been made in view of the above problems, and it is an object of the present invention to provide a technique of accurately identifying software from which a video file is transmitted. The video file goes through a unique re-encoding process in each software in the transmission process, and thus metadata may be changed. The present invention proposes a technique of identifying source software of a video based on the change in the metadata of each software.

To this end, the present invention proposes a technique of analyzing metadata in a video file and identifying a unique processing method of software, and tracing software from which the video file is transmitted. In particular, as the present invention proposes an algorithm that can effectively extract various metadata, preprocess the metadata, and reliably classify the source of software, the source software can be accurately identified by comprehensively analyzing the container structure of the video file, the characteristics of the video and audio streams, the encoding parameter, and the like.

In addition, an object of the present invention is to contribute to identifying videos of unknown source, such as malicious code or illegally filmed materials, and preventing distribution of the videos in advance. Therefore, the counterattack to cybercrimes is enhanced, and the accuracy of collecting and analyzing digital evidences is increased.

Meanwhile, the technical problems of the present invention are not limited to the technical problems mentioned above, and unmentioned other technical problems can be clearly understood by those skilled in the art from the following description.

To accomplish the above objects, according to one aspect of the present invention, there is provided a method performed by an apparatus for identifying video source software operated by a processor, the method comprising: an operation of acquiring a dataset including a video file transmitted by predetermined software; an operation of extracting a value of metadata including a container file format of each video file, internal data of a container file, and an encoding parameter; and an operation of generating a classification model based on a deep learning algorithm that has learned a parameter reflecting a correlation between the value of the metadata of each video and software from which each video file is transmitted.

In addition, the step of extracting metadata may include: an operation of extracting a value of metadata that specifies a type and an order of a top-level container file format as a container file format of each video file; an operation of extracting values of general metadata of the container file, video metadata of a video stream, and audio metadata of an audio stream, as internal data of the container file of each video file; an operation of extracting a value of metadata including a sequence parameter set (SPS) and a picture parameter set (PPS) as an encoding parameter of each video file; and an operation of labeling the extracted value of metadata for each metadata, and labeling a class that specifies software from which the video is transmitted as an answer class.

In addition, the value of the general metadata may include internal data contained in the boxes of ftyp, moov, and udta among the container file formats.

In addition, the value of the video metadata may include trak, of which a component subtype value of path moov/trak/mdia/hdlr is ‘vide’, among the container file formats.

In addition, the value of the audio metadata may include trak, of which a component subtype value of path moov/trak/mdia/hdlr is ‘soun’, among the container file formats.

In addition, the value of metadata including the SPS and PPS may include a bit string in box avcC of path moov/trak/mdia/hdlr among the container file formats.

In addition, when the extracted value of metadata includes a character string, the labeling operation may include: an operation of defining a predetermined integer that specifies each word included in the character string; an operation of encoding each word into an integer index on the basis of the defined integer; an operation of converting the integer index into a low-dimensional numeric string by reducing a dimension of the integer index of the metadata on the basis of a Principal Component Analysis (PCA) technique; and an operation of labeling the metadata with the low-dimensional numeric string.

In addition, when the extracted value of metadata does not include a character string, the labeling operation may include an operation of labeling the metadata with the numeric string.

In addition, the method may further comprise an operation of determining a source of software, from which a target video file is transmitted, by inputting the target video file into the classification model.

An apparatus for identifying video source software according to an embodiment may comprise: a memory including instructions; and a processor that performs a predetermined operation based on the instructions, wherein the operation of the processor includes: an operation of acquiring a dataset including a video file transmitted by predetermined software; an operation of extracting a value of metadata including a container file format of each video file, internal data of a container file, and an encoding parameter; and an operation of generating a classification model based on a deep learning algorithm that has learned a parameter reflecting a correlation between the value of the metadata of each video and software from which each video file is transmitted.

### BRIEF DESCRIPTION OF THE DRAWINGS

FIG. 1 is a view showing the configuration of an apparatus for identifying video source software according to an embodiment.

FIG. 2 is a flowchart illustrating the operation performed by an apparatus for identifying video source software according to an embodiment.

FIG. 3 is an exemplary view showing an ISOBMFF-based multimedia container according to an embodiment.

FIG. 4 is a flowchart illustrating the operation of step S1020 according to an embodiment in detail.

FIG. 5 is an exemplary view showing the operation of extracting metadata including a container file format according to an embodiment.

FIG. 6 is an exemplary view showing the operation of extracting metadata including internal data of a container file according to an embodiment.

FIG. 7 and FIG. 8 are exemplary views showing the operation of extracting metadata including an encoding parameter according to an embodiment.

FIG. 9 is an exemplary view comprehensively showing the types of metadata extracted according to the embodiments of FIGS. 5 to 8.

FIG. 10 is a flowchart illustrating the operation of step S1024 according to an embodiment in detail.

FIG. 11 is an exemplary view showing the concept of data conversion according to step S1024 according to an embodiment.

### DETAILED DESCRIPTION OF THE PREFERRED EMBODIMENT

Details of the objects and technical configurations of the present invention and operational effects according thereto will be more clearly understood by the following detailed description based on the drawings attached in the specification of the present invention. An embodiment according to the present invention will be described in detail with reference to the accompanying drawings.

The embodiments disclosed in this specification should not be construed or used as limiting the scope of the present invention. For those skilled in the art, it is natural that the description including the embodiments of the present specification have various applications. Accordingly, any embodiments described in the detailed description of the present invention are illustrative for better describing of the present invention, and are not intended to limit the scope of the present invention to the embodiments.

The functional blocks shown in the drawings and described below are merely examples of possible implementations. Other functional blocks may be used in other implementations without departing from the spirit and scope of the detailed description. In addition, although one or more functional blocks of the present invention are expressed as separate blocks, one or more of the functional blocks of the present invention may be combinations of various hardware and software configurations that perform the same function.

In addition, the expressions including certain components are expressions of “open type” and only refer to existence of corresponding components, and should not be construed as excluding additional components.

Furthermore, when a certain component is referred to as being “connected” or “coupled” to another component, it may be directly connected or coupled to another component, but it should be understood that other components may exist in between.

Hereinafter, various embodiments of the present invention will be described with reference to the accompanying drawings. However, it should be understood that this is not intended to limit the present invention to specific embodiments, but to include various modifications, equivalents, and/or alternatives of the embodiments of the present invention.

The present invention proposes a technique of analyzing metadata in a video file and identifying a unique processing method of software, and tracing software from which the video file is transmitted.

In particular, as the present invention proposes an algorithm that can effectively extract various metadata, preprocess the metadata, and reliably classify the source of software, the source software can be accurately identified by comprehensively analyzing the container structure of the video file, the characteristics of the video and audio streams, the encoding parameter, and the like.

Hereinafter, the configuration of an apparatus 100 for identifying video source software for implementing the present invention and the operation performed by the apparatus 100 for identifying video source software will be examined.

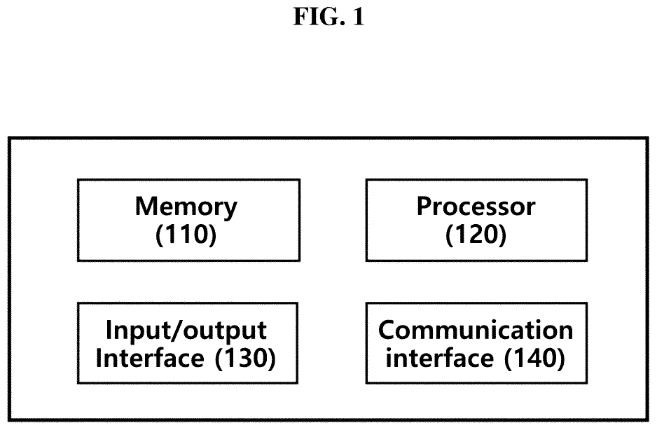

FIG. 1 is a view showing the configuration of an apparatus 100 for identifying video source software according to an embodiment (hereinafter referred to as an ‘apparatus 100’).

Referring to FIG. 1, the apparatus 100 according to an embodiment may include a memory 110, a processor 120, an input/output interface 130, and a communication interface 140.

The memory 110 may store data acquired from an external device or data generated by itself. The memory 110 may store instructions that may perform the operation of the processor 120. For example, the memory 110 may store datasets including video files transmitted by predetermined software, a classification models to be trained using the datasets, instructions that perform the operations for training the classification models, and the like.

The processor 120 is a computing device that controls the overall operation. The processor 120 may execute instructions stored in the memory 110. The operation of the apparatus 100 according to the embodiment of this document may be understood as an operation performed by the processor 120.

The input/output interface 130 may include a hardware interface or a software interface for inputting or outputting information.

The communication interface 140 allows to transmit and receive information through a communication network. To this end, the communication interface 140 may include a wireless communication module or a wired communication module.

The apparatus 100 may be implemented in various types of apparatuses 100 that can perform an operation through the processor 120 and transmit and receive information through a network. For example, although the apparatus 100 may be implemented as a server, a computer apparatus 100, a portable communication apparatus 100, a smart phone, a portable multimedia apparatus 100, a laptop computer, a tablet PC, or the like, it is not limited to these examples.

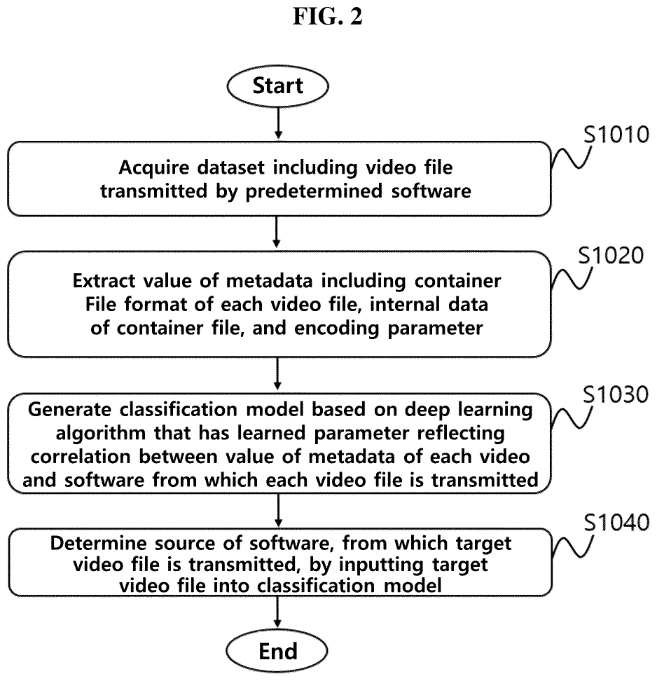

FIG. 2 is a flowchart illustrating the operation performed by the apparatus 100 according to an embodiment. The operation of the apparatus 100 according to the embodiment of FIG. 2 may be understood as an operation performed by the processor 120.

Each step disclosed in FIG. 2 is merely a preferred embodiment in achieving the objects of the present invention, and some steps may be added or deleted as needed, and any one step may be included and performed in another step. The order of each operation disclosed in FIG. 2 is arranged only for convenience of understanding, and this order is not limited to a time-series order, and the order may be changed to operate in a different way according to the choice of the designer.

Referring to FIG. 2, at step S1010, the apparatus 100 may acquire a dataset including at least a video file having been transmitted through software. It is assumed that each video file included in the dataset includes information on the source of software that has transmitted the video file.

A video file basically includes information such as the video streams, audio streams, subtitles, chapters, and the like. At this point, the format that allows the information such as the video streams, audio streams, subtitles, chapters, and the like to be stored in an integrated manner is called a multimedia container. That is, a video file is configured in a multimedia container format that may include all data such as videos, audios, subtitles, and the like, and there are various types of multimedia container formats, such as MP4, MOV, and AVI.

Hereinafter, although the multimedia container is described based on the MP4 format in the description of the present invention for convenience of understanding, the embodiments to which the present invention can be applied are not limited to the example of MP4 format, and can be applied to various formats.

Meanwhile, MP4 is a file format created by ISO/IEC, which uses the MPEG-4 part 14 standards, and is a video format created based on ISO/IEC Base Media File Format (ISOBMFF).

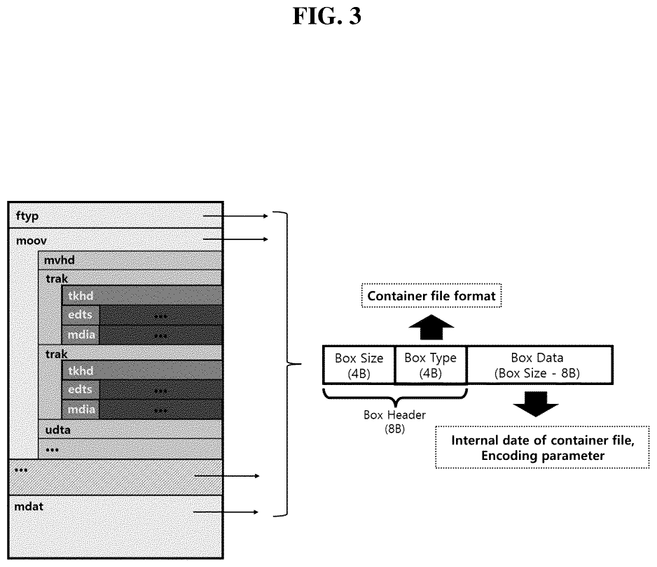

FIG. 3 is an exemplary view showing an ISOBMFF-based multimedia container according to an embodiment.

Referring to FIG. 3, a multimedia container is configured of boxes that manage specific types of data, and the boxes are configured in a hierarchical structure where the top-level box contains inner boxes.

The top-level box shown in FIG. 3 corresponds to ftyp, moov, and mdat. Each box of ftyp, moov, and mdat is configured of the units of Box Size, Box Type, and Box Data. Box Size is data that defines the size of a box, Box Type is data that specifies the type of a box, and Box Data may store internal data included according to the type of a box.

For example, ftyp is a box that confirms the compatibility of a file. moov is a box that stores all metadata. Boxes newly added to the video file by a specific software itself, such as mvhd, trak, and tkhd, may exist in moov. mdat is a box that stores actual video and audio data. The location of boxes, except the ftyp box, may vary according to encoded software.

That is, when a video file is transmitted through a specific software, the internal metadata of the video file may be changed through the unique re-encoding process of the software.

In view of this concept, the apparatus 100 may identify the source software that has transmitted the video by extracting metadata that is changed when a video is transmitted for each software according to the operation described below, performing a labeling operation, and training a classification model through the metadata. Accordingly, when a target video is input, the classification model that has completed the training is trained to determine by which software the target video has been transmitted, i.e., the source of software that has transmitted the target video.

Accordingly, the steps described below represent the process of creating a classification model by processing a dataset, and using the classification model.

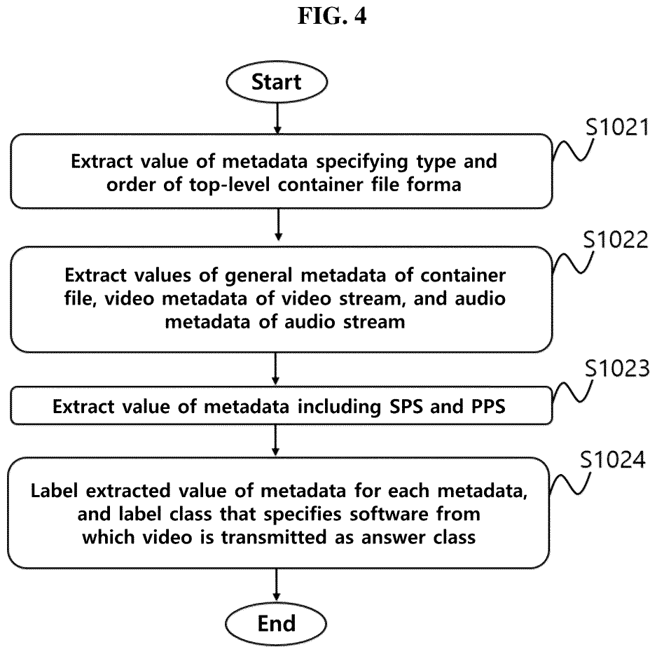

At step S1020, the apparatus 100 may extract the value of metadata including the container file format of each video file included in the dataset, internal data of the container file, and an encoding parameter. A specific embodiment of extracting the metadata is described below with reference to FIG. 4.

FIG. 4 is a flowchart illustrating the operation of step S1020 according to an embodiment in detail.

Each step disclosed in FIG. 4 is merely a preferred embodiment in achieving the objects of the present invention, and some steps may be added or deleted as needed, and any one step may be included and performed in another step. The order of each operation disclosed in FIG. 4 is arranged only for convenience of understanding, and this order is not limited to a time-series order, and the order may be changed to operate in a different way according to the choice of the designer.

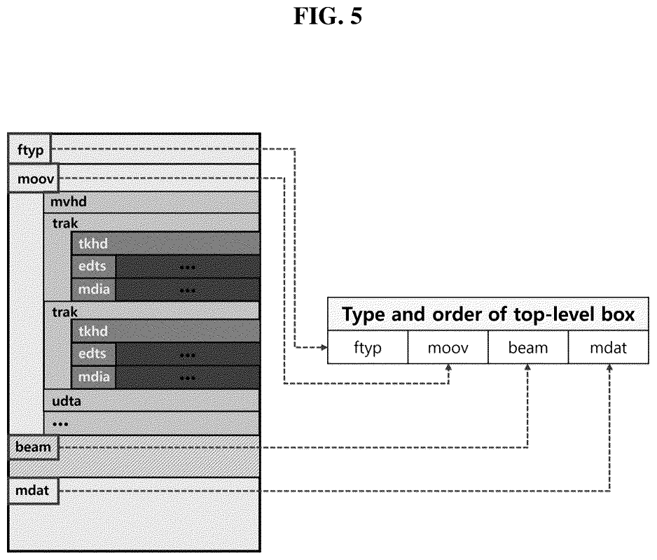

Referring to FIG. 4, at step S1021, the apparatus 100 may extract the value of metadata including the type and order of the top-level container file format as the container file format of each video file. The operation of step S1021 is described with reference to FIG. 5.

FIG. 5 is an exemplary view showing the operation of extracting metadata including a container file format according to an embodiment.

Referring to FIG. 5, the apparatus 100 may extract the types of top-level container file formats ftyp, moov, beam, and mdat from an ISOBMFF-based multimedia container, and store the extracted file formats in the order of ftyp, moov, beam, and mdat so that the order in which the top-level container file formats are arranged in the multimedia container can be specified. According to the example of FIG. 5, from the metadata including the types and order of the top-level container file formats, character string information of ‘ftyp moov beam mdat’ may be extracted as the value of corresponding metadata.

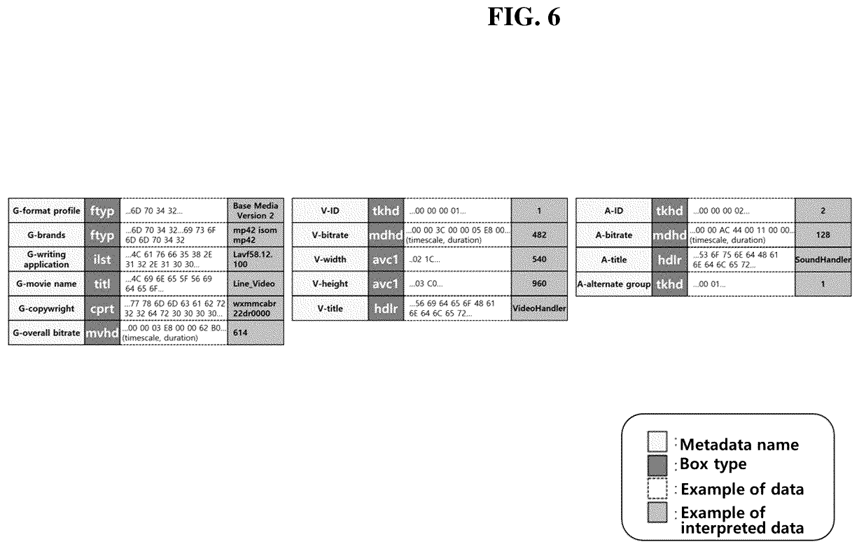

At step S1022, the apparatus 100 may extract general metadata of the container file, video metadata of the video stream, and audio metadata of the audio stream, as internal data of the container file of each video file. The operation of step S1022 is described with reference to FIG. 6.

FIG. 6 is an exemplary view showing the operation of extracting metadata including internal data of a container file according to an embodiment.

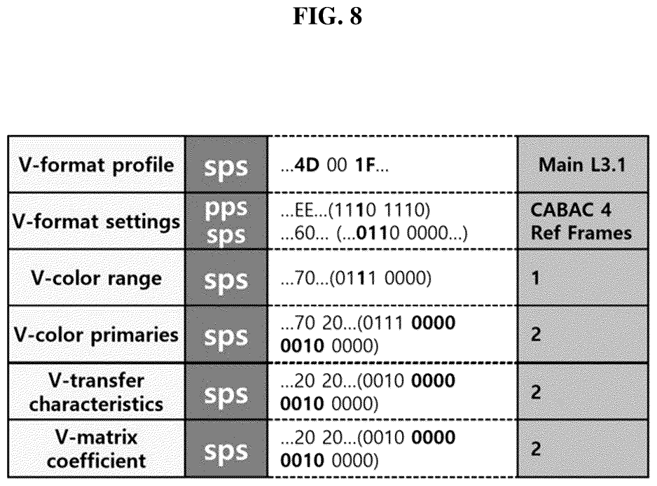

Referring to FIG. 6, the apparatus 100 may extract the value of general metadata (e.g., VM-G in FIG. 8) including the internal data contained in the boxes of ftyp, moov, and udta among the container file formats. In addition, the apparatus 100 may extract the value of video metadata (e.g., VM-V in FIG. 8) including trak, of which the component subtype value of path moov/trak/mdia/hdlr is ‘vide’, among the container file formats. In addition, the apparatus 100 may extract the value of audio metadata (e.g., VM-A in FIG. 8) including trak, of which the component subtype value of path moov/trak/mdia/hdlr is ‘soun’, among the container file formats.

For example, the apparatus 100 may extract bit string data corresponding to each item (e.g., G-format profile, G-brands, etc.) from the metadata of a video file, and map information (e.g., Base Media Version 2, mp42 isom mp42, etc.) for interpreting the meaning of the bit string included in each metadata on the basis of a file format specification document that defines the meaning of the bit string.

Here, the file format specification document is a reference material used to interpret the bit string data extracted from the internal data of the container file format, define the meaning of the data, and convert the data into comprehensible information.

Specifically, metadata of a video file contains bitstreams encoded according to various formats and rules, and although these bitstreams are generally stored based on specific standards or specifications, information on what each bitstream represents is required to interpret their meanings. At this point, the file format specification document may provide reference information for interpreting the bitstreams.

According to the example of FIG. 6, character string information of ‘Base Media Version 2’ may be extracted in the metadata of the G-format profile as the value of corresponding metadata. In addition, numeric string information of ‘614’ may be extracted in the metadata of the G-overall bitrate as the value of corresponding metadata.

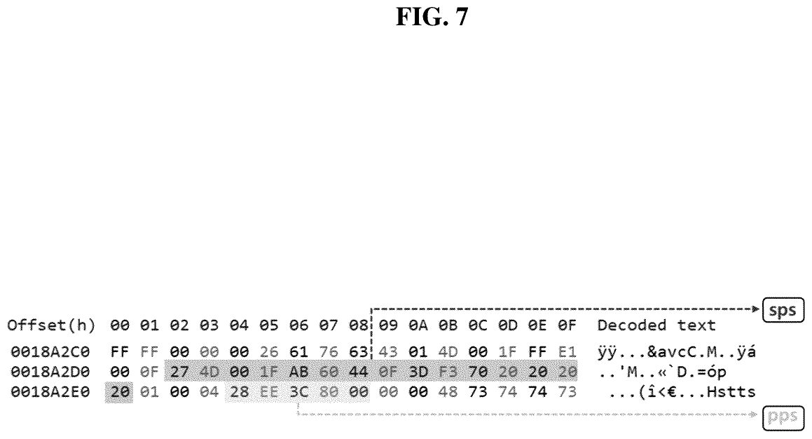

At step S1023, the apparatus 100 may extract metadata including a sequence parameter set (SPS) and a picture parameter set (PPS) as the encoding parameter of each video file. The operation of step S1023 is described with reference to FIGS. 7 and 8.

FIG. 7 and FIG. 8 are exemplary views showing the operation of extracting metadata including an encoding parameter according to an embodiment.

Referring to FIG. 7, the apparatus 100 may extract the value of the metadata of the encoding parameter from a bit string in the box avcC of the path moov/trak/mdia/hdlr among the container file formats.

Referring to FIG. 8, the apparatus 100 may extract bit string data corresponding to each item (e.g., V-format profile, V-format settings, etc.) from the box avcC, and map information (e.g., Main L3.1, CABAC 4 Ref Frames, etc.) for interpreting the meaning of the bit string included in each metadata on the basis of a file format specification document that defines the meaning of the bit string.

Here, the file format specification document is a reference material used to interpret the bit string data extracted from the encoding parameter, define the meaning of the data, and convert it into comprehensible information.

According to the examples of FIGS. 7 and 8, character string information of ‘Main L3.1’ may be extracted in the metadata of the V-format profile as the value of corresponding metadata.

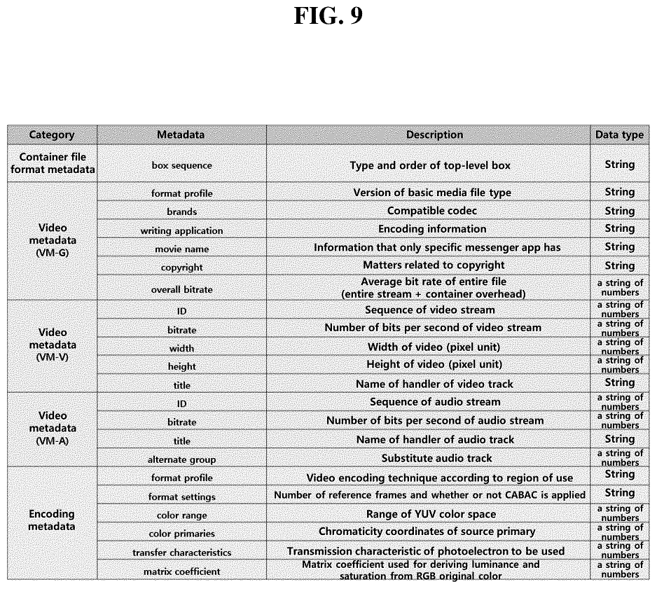

At step S1024, on the basis of each video file, the apparatus 100 may label the extracted value of metadata for each metadata of each video file, and label a class that specifies the software from which the video is transmitted as the answer class of the video file. Meanwhile, the apparatus 100 may apply a different labeling method according to the type of the value (e.g., a character string, a numeric string, etc.) of the metadata included in the video file. Before describing the labeling method, the types of the values of the metadata included in a video file will be described with reference to FIG. 9.

FIG. 9 is an exemplary view comprehensively showing the types of metadata extracted according to the embodiments of FIGS. 5 to 8.

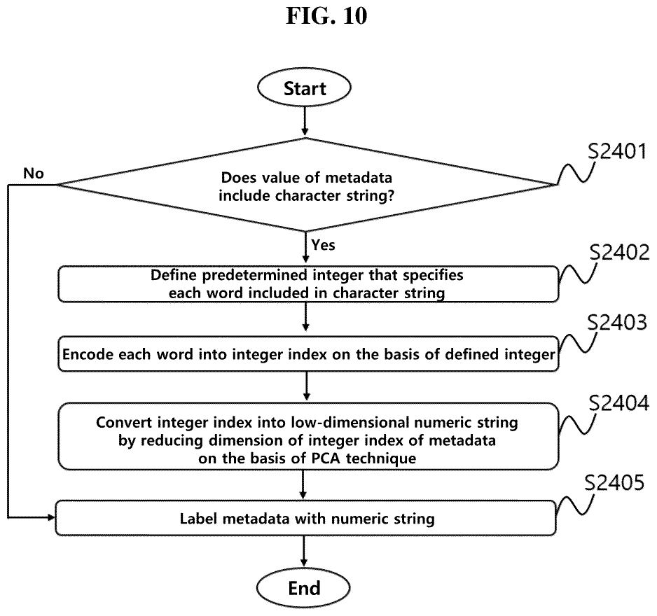

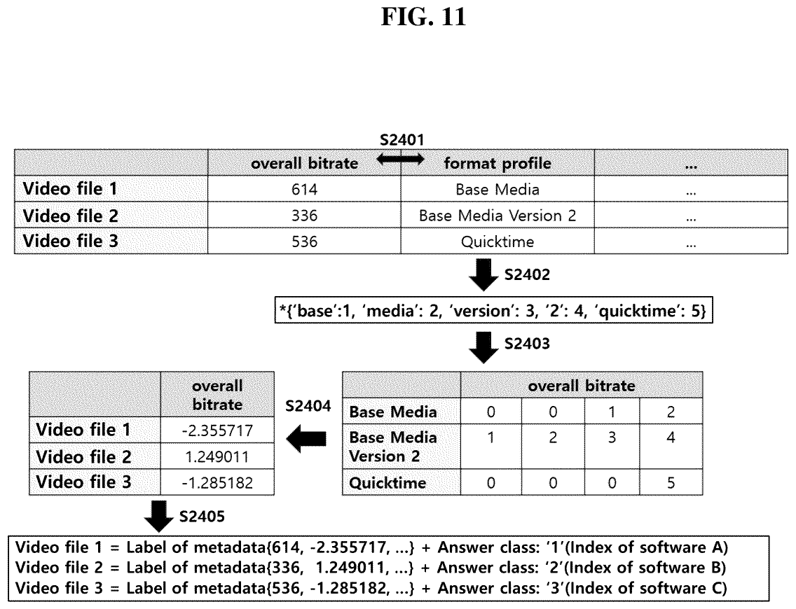

Referring to FIG. 9, the value of the metadata extracted through FIGS. 5 to 7 may be configured in the form of a character string or a numeric string. In an embodiment of the present invention, when the value of the metadata is a character string, the character string may be transformed into a numeric string to perform a labeling operation. The operation of step S1024 will be described with reference to FIGS. 10 and 11.

FIG. 10 is a flowchart illustrating the operation of step S1024 according to an embodiment in detail. FIG. 11 is an exemplary view showing the concept of data conversion according to step S1024 according to an embodiment.

Each step disclosed in FIGS. 10 and 11 is merely a preferred embodiment in achieving the objects of the present invention, and some steps may be added or deleted as needed, and any one step may be included and performed in another step. The order of each operation disclosed in FIGS. 10 and 11 is arranged only for convenience of understanding, and this order is not limited to a time-series order, and the order may be changed to operate in a different way according to the choice of the designer.

Referring to FIGS. 10 and 11 together, at step S2401, the apparatus 100 may classify first metadata in which the value of each metadata extracted from a video file includes a character string (including the cases in which numbers and characters are included together), and second metadata that does not include a character string.

Accordingly, steps S2402 to S2404 correspond to a preprocessing process of the first metadata. In describing the first metadata below, it will be described considering even the numbers included in the first metadata as a character string.

At step S2402, the apparatus 100 may define a predetermined integer that specifies each word included in the character string of the first metadata. For example, when the character string ‘Base Media Version 2’ is extracted as metadata, each of ‘Base’, ‘Media’, ‘Version’, and ‘2’ is converted into a unique integer. This process is a preparatory step for identifying each word in the character string and converting it into an integer index.

At step S2403, the apparatus 100 may encode each word included in the character string of the first metadata into an integer index on the basis of the defined integer. For example, a unique integer index value such as 1 for ‘Base’, 2 for ‘Media’, 3 for ‘Version’, and 4 for ‘2’ may be assigned.

At step S2404, the apparatus 100 may convert the integer index into a low-dimensional numeric string by reducing the dimension of the integer index of the first metadata on the basis of the Principal Component Analysis (PCA) technique.

That is, since the integer index encoded in the example of step S2403 is expressed as four-dimensional high-dimensional data, a process of reducing the dimension of the integer index may be performed using the Principal Component Analysis (PCA) technique. In this process, the high-dimensional characteristic of the encoded integer index may be converted into a low-dimensional numeric string, and this allows the classification model to process and analyze data more easily.

At step S2405, the apparatus 100 may label the first metadata with the converted low-dimensional numeric string.

Additionally, at step S2405, in the case of the second metadata, the apparatus 100 may label the second metadata with the original numeric string.

The metadata labeled in this way may be used for supervised learning of the classification model, together with the answer class that identifies the source software of the video file. Accordingly, each video file may be labeled with a label that identifies the characteristics of each metadata file and class information that identifies software from which the video file is transmitted.

At step S1030, the apparatus 100 may generate a classification model based on a deep learning algorithm that has learned a parameter reflecting the correlation between the metadata of each video and software from which each video file is transmitted.

Here, a model based on various neural network designs may be adopted as the classification model. For example, the apparatus 100 may use a classification model based on ExtraTrees for training. The apparatus 100 may input label information for the metadata of each video into the input layer of the classification model and input the answer class of each video file into the output layer of the classification model so that the parameters of the classification model may be learned.

At this point, the parameters include learning parameters of the neural network including weights and biases, and may be optimized in the direction of minimizing the loss function for the input learning data. For example, the loss function may be configured of cross-entropy, and an optimization algorithm such as stochastic gradient descent, Adam, or the like may be applied.

At step S1040, the apparatus 100 may determine the source of software, from which a target video file is transmitted, by inputting the target video file into the classification model that has completed the learning. For example, the apparatus 100 may extract metadata from the target video file through the same process as step S1020 described above, and input the extracted metadata into the classification model so that the classification model may determine the source of software from which the target video is transmitted.

According to the embodiment described above, as the present invention provides a technique of analyzing metadata of a video file and accurately identifying software from which the video is transmitted, the source of the video file can be traced efficiently. Therefore, distributors of problematic videos, such as illegally filmed materials or copyright infringements, can be specified promptly, and this may be utilized as an important evidence in the process of digital forensic analysis.

To this end, the present invention may significantly improve the accuracy of source identification compared to existing metadata analysis methods by comprehensively analyzing various types of metadata, including the container structure of a video file, video and audio streams, encoding parameters, and the like. In particular, the present invention is technically different in that it can clearly distinguish software that has transmitted a video even when videos have the same file structure, through a metadata analysis that reflects a re-encoding process uniquely applied to each software.

Therefore, the present invention may be utilized as a preventive technique that contributes to ensuring reliability and integrity of a video file. Furthermore, it will greatly contribute to creating a safe digital environment by reducing the risk of users downloading or executing malicious videos.

It should be understood that various embodiments of this document and the terms used herein are not intended to limit the technical features described in this document to specific embodiments, but include various modifications, equivalents, or substitutes of the embodiments. In connection with the description of drawings, similar reference numerals may be used for similar or related components. The singular form of a noun corresponding to an item may include one or more items, unless the related context clearly indicates otherwise.

In this document, each of phrases such as “A or B”, “at least one among A and B”, “at least either A or B”, “A, B, or C”, “at least one among A, B, and C”, and “at least either A, B, or C” may include all possible combinations of the items listed together in a corresponding phrase among the phrases. Terms such as “1st”, “2nd”, “first”, or “second” may be used only to distinguish a corresponding component from another corresponding component, and do not limit the components in any other aspect (e.g., importance or order). When a certain (e.g., a first) component is referred to as being “coupled” or “connected” to another (e.g., a second) component with or without a term such as “functionally” or “communicatively”, it means that the component may be connected to another component directly (e.g., wired), wirelessly, or through a third component.

The term “module” used in this document may include a unit implemented in hardware, software, or firmware, and may be used interchangeably with terms such as logic, logic block, part, or circuit. A module may be an integrally configured component, or a minimum unit of a component or a portion thereof that performs one or more functions. For example, according to an embodiment, a module may be implemented in the form of an application-specific integrated circuit (ASIC).

Various embodiments of this document may be implemented as software (e.g., a program) including one or more commands stored in a storage medium (e.g., a memory) that can be read by a device (e.g., an electronic device). The storage medium may include a random-access memory (RAM), a memory buffer, a hard drive, a database, an erasable programmable read-only memory (EPROM), an electrically erasable read-only memory (EEPROM), a read-only memory (ROM), and/or the like.

In addition, the processor in the embodiments of this document may call at least one command among one or more stored commands from the storage medium and execute the command. This allows the device to operate to perform at least one function according to the called at least one command. The one or more commands may include a code generated by a compiler or a code that can be executed by an interpreter. The processor may be a general-purpose processor, a Field Programmable Gate Array (FPGA), an Application Specific Integrated Circuit (ASIC), a Digital Signal Processor (DSP), and/or the like.

The storage medium that can be read by a device may be provided in the form of a non-transitory storage medium. Here, ‘non-transitory’ only means that the storage medium is a tangible device and does not include signals (e.g., electromagnetic waves), and this term does not distinguish the cases where data is stored semi-permanently on the storage medium from the cases where data is stored temporarily.

The method according to various embodiments disclosed in this document may be provided to be included in a computer program product. The computer program product may be traded between a seller and a buyer as goods. The computer program product may be distributed in the form of a machine-readable storage medium (e.g., a compact disc read only memory (CD-ROM)), or may be distributed online (e.g., downloaded or uploaded) through an application store (e.g., Play Store) or directly distributed between two user devices (e.g., smartphones). In the case of online distribution, at least a part of the computer program product may be at least temporarily stored in a machine-readable storage medium, such as a memory of a manufacturer's server, an application store's server, or a server, or may be temporarily generated.

According to various embodiments, each component (e.g., a module or a program) of the components described above may include a single or a plurality of entities. According to various embodiments, one or more of the components or operations of the components described above may be omitted, or one or more other components or operations may be added. Alternatively or additionally, a plurality of components (e.g., modules or a programs) may be integrated into a single component. In this case, the integrated component may perform one or more functions of each of the plurality of components in a way identical or similar to those performed by the corresponding component among the plurality of components before the integration. According to various embodiments, the operations performed by the modules, programs, or other components may be executed sequentially, in parallel, repeatedly, or heuristically, or one or more of the operations may be executed in a different order or omitted, or one or more other operations may be added.

As the present invention provides a technique of analyzing metadata of a video file and accurately identifying software from which the video is transmitted, the source of the video file can be traced efficiently. Therefore, distributors of problematic videos, such as illegally filmed materials or copyright infringements, can be specified promptly, and this may be utilized as an important evidence in the process of digital forensic analysis.

To this end, the present invention may significantly improve the accuracy of source identification compared to existing metadata analysis methods by comprehensively analyzing various types of metadata, including the container structure of a video file, video and audio streams, encoding parameters, and the like. In particular, the present invention is technically different in that it can clearly distinguish software that has transmitted a video even when videos have the same file structure, through a metadata analysis that reflects a re-encoding process uniquely applied to each software.

Therefore, the present invention may be utilized as a preventive technique that contributes to ensuring reliability and integrity of a video file. Furthermore, it will greatly contribute to creating a safe digital environment by reducing the risk of users downloading or executing malicious videos.

Meanwhile, the effects of the present invention are not limited to those mentioned above, and unmentioned other technical effects will be clearly understood by those skilled in the art from the following descriptions.

### DESCRIPTION OF SYMBOLS

100: Device
110: Memory
120: Processor
130: Input/Output interface
140: Communication interface

What is claimed is:

1. A method performed by an apparatus for identifying video source software operated by a processor, the method comprising:
an operation of acquiring a dataset including a video file transmitted by predetermined software;
an operation of extracting a value of metadata including a container file format of each video file, internal data of a container file, and an encoding parameter; and
an operation of generating a classification model based on a deep learning algorithm that has learned a parameter reflecting a correlation between the value of the metadata of each video and software from which each video file is transmitted.

2. The method according to claim 1, wherein the step of extracting metadata includes:
an operation of extracting a value of metadata that specifies a type and an order of a top-level container file format as a container file format of each video file;
an operation of extracting values of general metadata of the container file, video metadata of a video stream, and audio metadata of an audio stream, as internal data of the container file of each video file;
an operation of extracting a value of metadata including a sequence parameter set (SPS) and a picture parameter set (PPS) as an encoding parameter of each video file; and
an operation of labeling the extracted value of metadata for each metadata, and labeling a class that specifies software from which the video is transmitted as an answer class.

3. The method according to claim 2, wherein the value of the general metadata includes internal data contained in boxes of ftyp, moov, and udta among the container file formats.

4. The method according to claim 2, wherein the value of the video metadata includes trak, of which a component subtype value of path moov/trak/mdia/hdlr is ‘vide’, among the container file formats.

5. The method according to claim 2, wherein the value of the audio metadata includes trak, of which a component subtype value of path moov/trak/mdia/hdlr is ‘soun’, among the container file formats.

6. The method according to claim 2, wherein the value of metadata including the SPS and PPS includes a bit string in box avcC of path moov/trak/mdia/hdlr among the container file formats.

7. The method according to claim 2, wherein when the extracted value of metadata includes a character string, the labeling operation includes:
an operation of defining a predetermined integer that specifies each word included in the character string;
an operation of encoding each word into an integer index on the basis of the defined integer;
an operation of converting the integer index into a low-dimensional numeric string by reducing a dimension of the integer index of the metadata on the basis of a Principal Component Analysis (PCA) technique; and
an operation of labeling the metadata with the low-dimensional numeric string.

8. The method according to claim 2, wherein when the extracted value of metadata does not include a character string, the labeling operation includes an operation of labeling the metadata with the numeric string.

9. The method according to claim 1, further comprising an operation of determining a source of software, from which a target video file is transmitted, by inputting the target video file into the classification model.

10. An apparatus for identifying video source software, the apparatus comprising:
a memory including instructions; and
a processor that performs a predetermined operation based on the instructions, wherein
the operation of the processor includes:
an operation of acquiring a dataset including a video file transmitted by predetermined software;
an operation of extracting a value of metadata including a container file format of each video file, internal data of a container file, and an encoding parameter; and
an operation of generating a classification model based on a deep learning algorithm that has learned a parameter reflecting a correlation between the value of the metadata of each video and software from which each video file is transmitted.
